(19) United States
(12) Patent Application Publication
(10) Pub. No.: US 2016/0284234 A1
(43) Pub. Date: Sep. 29, 2016

(54) COMMUNICATING with NONVERBAL and LIMITED COMMUNICATORS

(71) Applicant: Barbara Huntress Tresness, Manlius, NY (US)

(72) Inventor: Barbara Huntress Tresness, Manlius, NY (US)

(21) Appl. No.: 15/078,766

(22) Filed: Mar. 23, 2016

Related U.S. Application Data
(60) Provisional application No. 62/137,646, filed on Mar. 24, 2015.

(51) Int. Cl. G09B 21/00

(52) U.S. Cl. CPC G09B 21/00

(57) ABSTRACT

A method of communicating with a nonverbal communicator by using a first article indicating an first answer, a second article indicating a second answer, and a guide containing a plurality of questions that elicit either the first or the second answer. The method comprises the steps of: (a) supporting the first and second articles apart from each other in front of the nonverbal communicator, such that the first and second answer choices are easily discernable and are selectable by the nonverbal communicator by a discriminating action in relation to the first or second article; (b) asking the nonverbal communicator at least one question from the portable guide; and (c) receiving from the nonverbal communicator either the first or second answer to the question, by perceiving a discriminating action relative to the first or second article made by the nonverbal communicator.

### CROSS-REFERENCE TO RELATED APPLICATIONS

This application claims the benefit of U.S. Provisional Application No. 62/137,646, filed Mar. 24, 2015, which is incorporated herein by reference.

### BACKGROUND OF THE INVENTION

1. Field of Invention

The present invention relates generally to the field of interpersonal communication involving people unable to verbally communicate or people having a limited ability to verbally communicate, and more particularly to apparatus and methods that enable a verbal communicator to communicate with such verbally challenged people.

2. Background Art

There exists a common and damaging perception that there is only one way for humans to communicate, and that is through clear, recognizable speech. And there is very little understanding or tolerance for even the slightest deviation from this perception. People who are capable of speaking normally (“verbal communicators” or the “verbal community”) can be quick to dismiss those who are incapable of speaking or have a limited ability to speak (“verbally handicapped”). Many verbal communicators will immediately assume that communication with a verbally handicapped person is impossible because the latter person cannot speak. Even those verbal communicators, who understand that such communication is possible, find it difficult, awkward or uncomfortable to carry on a conversation with a verbally handicapped person. Many verbal communicators lack the skill, training and tools to initiate and follow through with such a conversation. Thus, many verbally handicapped individuals experience little interaction or socialization with others outside of attentive family members and trained teachers, aides and therapists. As a result, verbally handicapped people can sometimes feel as if they are trapped inside their bodies or in a cage and are trying to get out. If they could only engage in communication with the verbal community, they could escape their bodies or the cage and contribute thoughts and ideas, voice opinions, advocate for themselves, participate in fun and educational activities, and reveal their personalities and senses of humor. Unfortunately, the verbally handicapped have little opportunity to engage the verbal community in that way, leaving them feeling isolated, left out, ignored, frustrated, or even fearful in some cases.

There are hundreds of thousands of verbally handicapped people in the world because of congenital disabilities, accidents, strokes, traumatic brain injuries, ALS, etc. Such people have been labeled by the public and by some care providers as “nonverbal.” This suggests that there isn't or shouldn't be any hope in communicating with them, which is absolutely false. Most verbally handicapped people have the ability to communicate, albeit on a nonverbal or partially verbal basis. In an effort to change the thinking, the inventor herein has advocated the use of the term “nonverbal communicator” for a person incapable of verbally communicating and the term “limited communicator” for a person with limited ability to verbally communicate. In each case, the message is that the person can communicate or is a communicator. Changing how verbally handicapped people are labeled is a first step toward changing the way they are perceived and treated. The inventor herein is firm in the belief that “everyone can communicate” or “everyone has the ability to communicate.”

Again, a nonverbal communicator is someone who cannot use his or her voice to talk. People who are nonverbal communicators still have thoughts, ideas and feelings to express. They need help to communicate. They use alternative ways to talk. Devices like switches, tablets and computers help or assist them. A limited communicator is someone who can use their voice to talk, but only in a limited way. Their voice might work, but they can only say a few words or their words might be hard to understand. They also need help to communicate. They need devices to help augment or assist their limited speech. Augment means to provide an additional aid for communicating beyond the ability of the limited communicator.

Electronic devices have been developed that enable nonverbal or limited (“NV/L”) communicators to engage in some form of verbal communication. Such devices normally include an electronic touch display screen and a graphical user interface. Messages or responses are composed from pictograms, letters, words, sentences, or other indicia displayed on the screen, which are selected by direct touching of the screen, by remote sensing of eye gazes or movements, blinking, or by sounds. The device synthesizes a verbal message (speech) from the indicia selected by the user and the message is played over a built-in speaker. An example of one such device is the Maestro™, an electronic tablet supplied by DynaVox, Pittsburgh, Pa. Such devices fall under a category referred to as augmentative and alternative communications (AAC) devices. Electronic AAC devices have been a wonderful tool to enable nonverbal and limited communicators to engage in a kind of verbal communication with others, for both utilitarian and social purposes. However, such devices can be misplaced, abandoned, stolen, or they can breakdown or lose battery power. For example, if the NV/L communicator is in an accident, the AAC device may become damaged (when it may be needed the most). In some circumstances, the operation of such devices is not practical or convenient. For example, the use of a AAC device may not be handy during a car ride, while traveling in a plane, in inclement weather, or while participating in outdoor activities such as skiing or swimming. Therefore, it would be prudent to carry along a backup communication system, which is reliable, low tech, very portable, and does not rely exclusively on powered electronics. In other words, there should be more than one tool in the communication toolbox.

Too often, verbal communicators fail to recognize a NV/L communicator, or, if they do, they assume they are unable or unwilling to communicate. Therefore, a need exists to provide an effective means of identifying NV/L communicators and conveying a clear message that says, in effect, “Hey, I'm a nonverbal (or limited) communicator. We all communicate; learn how to talk to me!” Such a means of identification and of creating awareness can be very helpful if the NV/L communicator is alone or if the electronic AAC device fails. In the case of a medical emergency involving a NV/L communicator, for example, it would be most regrettable if the NV/L communicator was not immediately recognized and effective communication not established.

A non-electronic system for communicating with a NV/L communicator has been proposed in the form of hand-held “Yes” and “No”, Green and Red, bands, which are used to respond to questions eliciting “yes” or “no” responses (“Yes/No questions”). See, for example, Teaching Learners with Multiple Special Needs: The Yes/No Series—Part One, by Kate Ahern, http://teachinglearnerswithmultipleneeds.blogspot. com/2012/11/the-yesno-series-part-one.html, November 2012; and Communi-Bands-Yes/No Wristbands, by Alison C., http://www. thegreencrab.com/communication%282273404%29.htm, January 2014. Both references suggest that the NV/L communicator wear the bands; however, the first reference suggests that Yes/No communication may be had with a NV/L communicator by presenting Yes/No “symbols” to the NV/L communicator and having him or her answer by pointing, head nodding or shaking, facial expressions, or eye-gazing toward the Yes or the No symbol. Another reference, entitled, Teaching Yes/No Responses, Glenda's Assistive Technology Information and more . . . Blog, by Glenda Anderson, http://atclassroom.blogspot.com/2009/04/yesno-responses.html, April 2009, also discusses Yes/No communication by presenting symbols and having the NV/L communicator point to the answer. A further reference, entitled, Teaching Learners with Multiple Special Needs: The Yes/No Series - Part Two, by Kate Ahern, http://teachinglearnerswithmultipleneeds.blogspot. com/2012/12/the-yesno-series-part-two.html, December 2012, discloses Yes/No squares, which are color-coded green and red and contain pictures of Yes and No hand signals. All of these devices are helpful in establishing communication between a NV/L communicator and a verbal communicator who has undergone some training in such communication and is probably familiar with the subject.

Other systems of communication have been used in an educational or clinical setting. For examples see U.S. Pat. Nos.: 4,954,083; 6,923,652; 2011/0171614; 2008/0108023; and 6,056,549. U.S. Pat. No. 4,954,083 discloses a look-through panel containing “Yes” and “No” answer choices held up in front of the NV/L communicator, who responds by eye-gazing to either “Yes” on one side or “No” on the other side of the panel (FIG. 1). U.S. Pat. No. 6,923,652 discloses the idea of presenting a Yes/No answer choice on a large card placed on an easel in front of a NV/L communicator, who responds by aiming an eyeglass frame-mounted light pen at the Yes or No answer. U.S. Pub. Patent App. 2011/0171614 presents a similar arrangement, except the answer choices are in electronic form. U.S. Pub. Patent App. 2008/0108023 discloses the message that the NV/L communicator is a communicator and can communicate with you and invites you to communicate with him or her (FIG. 1). Document 2008/0108023 further discloses a system of communicating by asking a series Yes/No questions, and the NV/L communicator responds by blinking her left eye for Yes and right eye for No. U.S. Pat. No. 6,056,549 discloses a loose-leaf book containing pictogram cards that can be removed from loose-leaf sheets in the book and placed on the cover of the book, using Velcro (FIGS. 1 & 2). The pictograms can be grouped together to form a statement or question. A Yes or No answer (see FIG. 7) can be given by placing a Yes or No card on the corner of the book. It is intended that the NV/L communicator physically select from the pictograms and place them on the book to communicate. The verbal communicator may also communicate doing the same (Col. 8).

Two other references disclose the use of Yes/No questions to engage in communication with a NV/L communicator in an educational, clinical or family setting. They are: Answering Simple Yes/No Questions, by Christopher J. Jenkins, Ph.D., Provincial Inclusion Outreach Program, Victoria, B. C., Canada, www.pisp.ca/strategies/strategies158.pdf, October 2014; and Yes? No? Maybe So . . . , by Phillip Harmuth, Mass., www.pisp.ca/strategies/documents/Yesnomaybeso.pdf, October 2014. The first of these two references discloses general guidelines when asking yes/no questions and a scripted routine to follow when asking yes/no questions. The second reference discusses methods and practices when communicating with yes/no questions.

The references discussed above are directed to methods of communicating with NV/L communicators in an educational, clinical or family setting, or are directed in general to primary caregivers. Notwithstanding these references, there remains a long felt and unfulfilled need to enlarge the universe of potential verbal communicators who will engage NV/L communicators, in all sorts of social settings or situations. Communicating with others outside of the usual group of caregivers will enhance socialization skills and build confidence in the NV/L communicator, and it offers the prospect of new relationships with and a better understanding by the verbal community. With such expanded opportunities, the intellectual and emotional health of all participants is likely to improve.

### OBJECTS AND SUMMARY OF THE INVENTION

It is therefore an object of the present invention to overcome the problems and shortcomings of the prior art.

It is another object of the present invention to demonstrate to the verbal community that effective and meaningful communication can be carried on with NV/L communicators.

It is a further object of the present invention to provide methods and apparatus that enable verbal communicators to communicate effectively with NV/L communicators.

It is yet another object of the present invention to provide methods and apparatus that enable verbal communicators with little or no training to communicate effectively with NV/L communicators.

It is yet a further object of the present invention to provide methods and apparatus that serve as reliable, low tech, very portable backup systems to electronic AAC devices, in the event that such electronic devices fail, are not available, or are inconvenient or impractical to operate under the circumstances.

It is still another object of the present invention to provide an effective way to positively identify NV/L communicators and clearly convey a message that such individuals are indeed communicators and are willing to communicate with verbal communicators.

It is still a further object of the present invention to increase the ability and confidence of families, teachers, healthcare providers, other caregivers, and the general public to interact, communicate and socialize with NV/L communicators.

It is still another object of the present invention to improve the quality of life of NV/L communicators by expanding their opportunities for communication with others.

These and other objects are attained in accordance with the present invention, wherein there is provided, in one particular embodiment, a method of communicating with a NV/L communicator by using a first article indicating an affirmative answer choice, a second article indicating a negative answer choice, and a portable guide containing a plurality of prepared questions that each elicit either an affirmative or a negative answer. The method comprises the steps of: (a) holding, wearing or otherwise supporting the first and the second articles spaced apart from each other in front of the NV/L communicator, such that the affirmative and the negative answer choices are easily discernable and are selectable by the NV/L communicator by a discriminating action of the NV/L communicator in relation to the first or the second article; (b) asking the NV/L communicator at least one of the plurality of prepared questions from the portable guide; and (c) receiving from the NV/L communicator either an affirmative or a negative answer to the at least one question, by perceiving a discriminating action in relation to the first or the second article made by the NV/L communicator in response to the at least one question. The method may further comprise the step of: (d) identifying a NV/L communicator person, for example, by having the person wear a dog tag around the neck, tying an ID tag around a belt or belt loop, wearing a t-shirt, or carrying a card, that indicates (in each case) that the person is a communicator, albeit a NV/L communicator.

In connection with the above method, the first and second articles may be wearable or hand-held articles, such as a wristbands, bracelets, mittens, gloves, palm protectors, sleeves, rings, flipcharts, etc. Moreover, the articles may be self-supporting or supported by a separate support structure. The first article may indicate an affirmative answer choice by having “YES” prominently printed on the article one or more times and/or by being colored green or yellow. Similarly, the second article may indicate a negative answer choice by having “NO” prominently printed on the article one or more times and/or by being colored red. The portable guide may be in the form of, for example, a paperboard fan-folded card, panel, sheet, booklet, or an electronic screen display generated by a smart phone, tablet, or other personal electronic device (e.g., as part of a software App). Preferably, the first and second articles are worn on the hands, wrists, or arms, respectively, of the verbal communicator, or otherwise held or supported, in order to position them in a spaced apart manner in front of the NV/L communicator. After a question is asked, the verbal communicator should be patient and give the NV/L communicator plenty of time to answer. It is expected that the answer will be given by some discriminating action on the part of the NV/L communicator such as, for example, a head nod, point, eye glance, left or right eye blink, body lean, or other motion toward or near the selected answer choice (first or second article), or by touching the hand, wrist or arm carrying the selected article, or by a sound or sounds. Further, the discriminating action may simply be looking down or away to indicate “no” and looking up or at the interrogator to indicate “yes.”

In one particular embodiment of the present invention, a method of communicating with a NV/L communicator person involves using two hand-held bands or wristbands to present a Yes/No answer choice to the person and asking the person a prepared Yes/No question from a portable guide. One band is marked with “Yes” indicia and the other band is marked with “No” indicia. The indicia may include the words “Yes” or “No” and/or a color indicating “Yes” or “No” (e.g., green or yellow for “Yes” and red for “No”). The bands are either held in the hands or worn around the wrists of the verbal communicator, in a manner that allows the NV/L communicator to clearly see and understand the Yes/No choice. The bands are very portable and can be easily stowed away in a pocket and brought out when communication with the NV/L communicator is desired. The bands facilitate meaningful and sociable communication with a NV/L communicator by asking a series of Yes/No questions. The series of Yes/No questions are provided in a portable guide maintained by the verbal communicator.

### BRIEF DESCRIPTION OF THE DRAWING

Further objects of the present invention will become apparent from the following description of the preferred embodiment, with reference to the accompanying drawing, in which:

FIG. 1 is a perspective view of a pair of “Yes” and “No” bands for use in accordance with the present invention;

FIG. 2 is a sketch illustrating how the “Yes” and “No” bands may be used in communicating with a NV/L communicator in accordance with the present invention;

FIGS. 3A-3C show a set of nine displays, each containing prepared Yes/No questions and other guidance, where each display, individually, or all displays, collectively, constitute a portable guide, and where the displays represent pages, sheets, segments, cards, or electronic screens;

FIGS. 4A-4C show three exemplary embodiments of a portable guide for use in practicing the present invention;

FIG. 5 is a sketch illustrating the “Yes” and “No” bands being worn around the wrists of a verbal communicator, who is presenting the bands as “Yes” and “No” answer choices to a nonverbal communicator person while asking the person a Yes/No question, and receiving an answer from the nonverbal communicator by a discriminating action (i.e., body movement and point) toward the “No” band;

FIG. 6 is a flow diagram outlining steps of a preferred method of the present invention;

FIG. 7 is a elevation view of a T-shirt to be worn by a NV/L communicator person for identifying the person as a NV/L communicator and inviting others to communicate with him/her;

FIG. 8 is an elevation view of ID tags to be tied to the clothing or wheelchair of a nonverbal or limited communicator person (as the case may be) for identifying the person as a nonverbal or limited communicator and conveying a message that the person is a communicator;

FIG. 9 is an elevation view of a dog tag to be worn around the neck of a NV/L communicator person for identifying the person as a NV/L communicator and conveying the message that the person is a communicator;

FIG. 10 is an elevation view, front and back, of a card (like a business card) to be carried by a NV/L communicator person for identifying the person as a nonverbal or limited communicator and inviting others to communicate with the person;

FIG. 11 is a front elevation view of a flipchart framework having a boom and a pair of flipchart rings at each end of the boom for supporting flipchart cards;

FIG. 12 shows samples of flipchart cards that may be used on the framework of FIG. 11;

FIG. 13 is a front elevation view of two blank flipchart cards, each including a clear plastic sleeve for receiving sheets imprinted with photographs, words, pictograms, etc., for communication by binary choice in accordance with the present invention; and

FIG. 14 shows a set of sheets imprinted with photographs of people, photographs or pictograms of rooms, and titles of movies, all known to the NV/L communicator.

### DETAILED DESCRIPTION OF THE PREFERRED EMBODIMENT

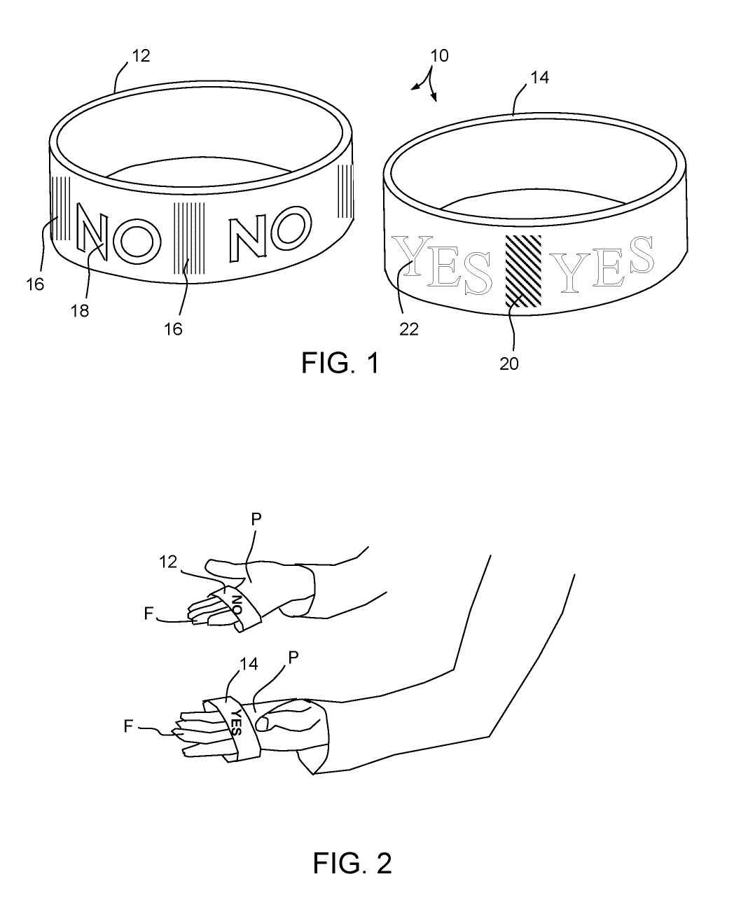

Referring now to FIG. 1, there is shown a pair of articles 10 in the form of rubberized bands for use in accordance with the present invention. A first article or band 12 contains indicia that indicates or signifies a negative or “No” response choice. The negative or “No” indicia on band 12 includes a red color 16 and a word 18 reading “No” repeated a number of times (e.g., 6 times) around band 12. Red color 16 may be presented as a shaded area or shape, multiple shaded areas or shapes, or the entire band 12 may be (and is preferably) colored red. The indicia may also include a symbol signifying a negative or “No” response, e.g., sign language symbols. A second article or band 14 contains indicia that indicates or signifies an affirmative or “Yes” response choice. The affirmative or “Yes” indicia on band 14 includes a green color 20 and a word 22 reading “Yes” repeated a number of times (e.g., 6 times) around band 14. Green color 20 (which may be yellow instead) may be a shaded area or shape, multiple shaded areas or shapes, or the entire band 14 may be (and is preferably) colored green. Bands 12 and 14 are preferably about 2.5 to 3 inches in diameter and made of Silicone rubber. They are preferably in the form of readily available Silicone rubber bracelets or wristbands. They are bright, durable, comfortable and washable. They are lead-free, latex-free, and bisphenol A- (BPA-) free. Bands 12 and 14 are very portable. They can be stowed in pockets of clothing or carry bags, and are ideal for traveling, for use in an emergency, or as a back-up to electronic AAC devices.

FIG. 2 is a sketch showing how bands 12 and 14 may be used in communicating with a NV/L communicator, in accordance with the present invention. FIG. 2 shows bands 12 and 14 being held or worn around the palms P or fingers F of a verbal communicator's hands. Bands 12 and 14 are being presented to a NV/L communicator to elicit responses from the NV/L communicator to one or more Yes/No questions. The bands help a verbal communicator initiate and engage in conversation and obtain information by posing Yes/No questions and encouraging the NV/L communicator to signal the band that correlates to his/her answer. This is discussed in more detail below. Another preferred way to use bands 12 and 14 is to wear them on the wrists, as shown in FIG. 5. The process of communicating with these bands, as illustrated in FIGS. 2 and 5, e.g., is also referred to by the inventor herein as “hand talk.”

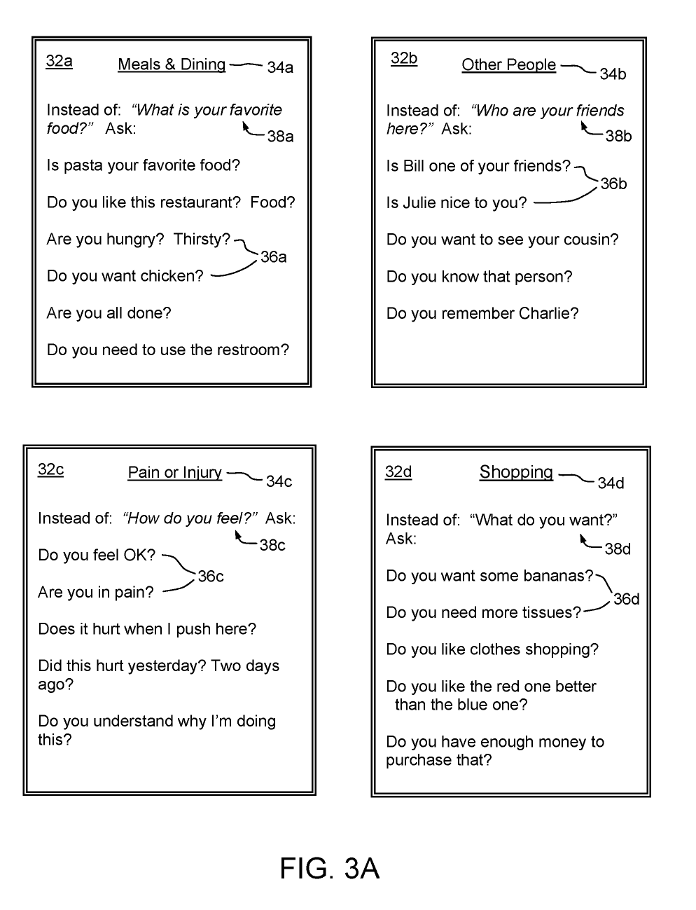

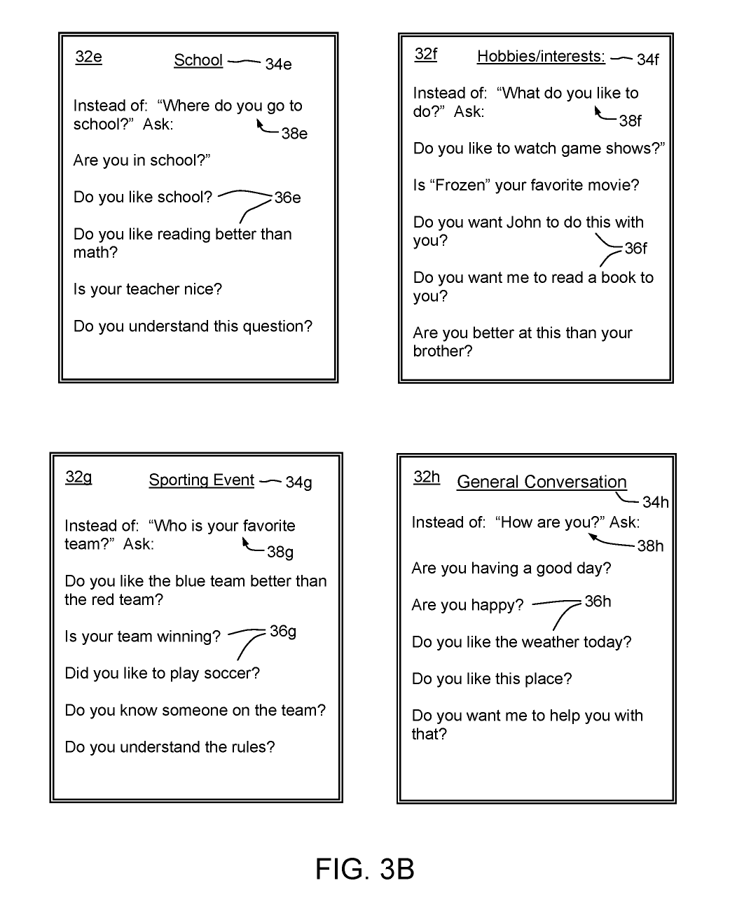

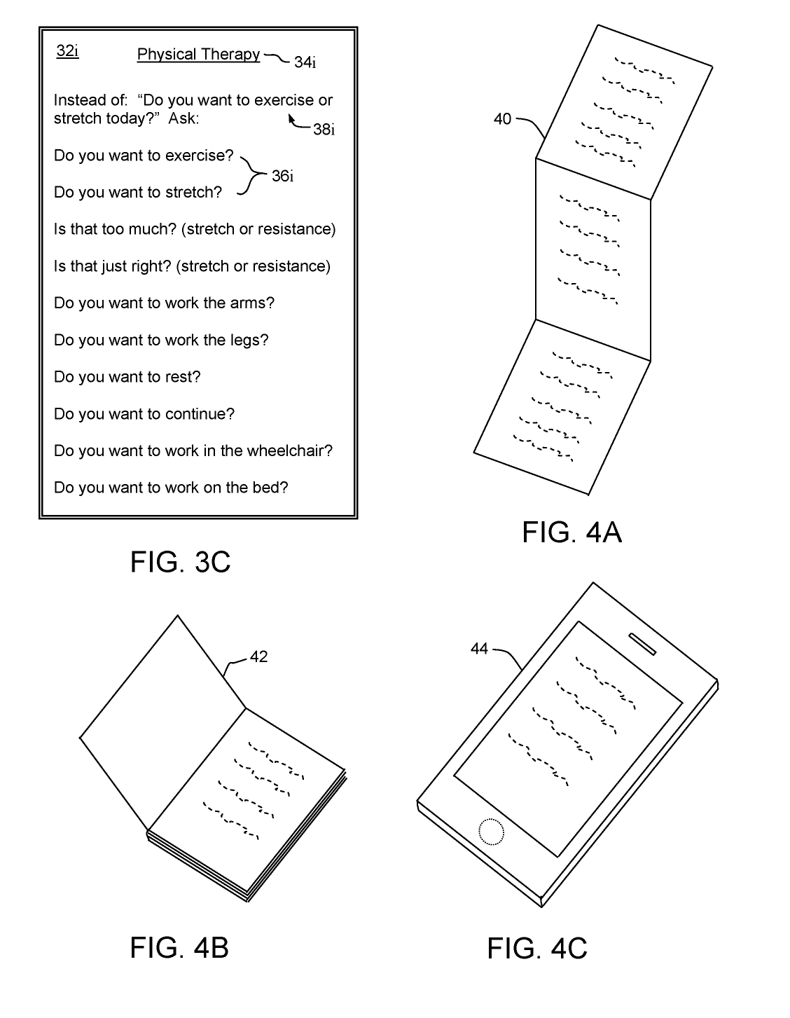

Referring to FIGS. 3A, 3B & 3C, there is shown nine displays 32a, 32b, 32c, 32d, 32e, 32f, 32g, 32h, and 32i each identified by an activity scenario 34a, 34b, 34c, 34d, 34e, 34f, 34g, 34h, and 34i, respectively. The displays also contain a collection of Yes/No questions 36a, 36b, 36c, 36d, 36e, 36f, 36g, 36h, and 36i, respectively. The questions of collections 36a-36i are relevant to their respective activity scenario 34a-34i. Collections 36a-36i serve as a reference or guide for verbal communicators (and typically untrained verbal communicators), to enable them to communicate (i.e., engage in conversation) with NV/L communicators. Communication may be necessary in case of an emergency or it may be for purely sociable reasons (i.e., to simply get to know the NV/L communicator). The Yes/No questions of collections 36a-36i are previously prepared questions, each eliciting either an affirmative or a negative answer (as previously defined). An “affirmative” answer is preferably a “Yes” answer, and a “negative” answer is preferably a “No” answer.

Collection 36a (FIG. 3A), on display 32a, includes examples of Yes/No questions pertaining to a “Meals & Dining” scenario 34a. The questions are:
Is pasta your favorite food?
Do you like this restaurant? Food?
Are you hungry? Thirsty?
Do you want chicken?
Are you all done?
Do you need to use the restroom?
   Also contained on display 32a is advice 38a on how not to phrase a question for scenario 34a:
Instead of: “What is your favorite food?” Ask: (the above Yes/No questions)

Collection 36b (FIG. 3A), on display 32b, includes examples of Yes/No questions pertaining to an “Other People” scenario 34b. The questions are:
Is Bill one of your friends?
Is Julie nice to you?
Do you want to see your cousin?
Do you know that person?
Do you remember Charlie?
   Also contained on display 32b is advice 38b on how not to phrase a question for scenario 34b:
Instead of: “Who are your friends here?” Ask: (the above Yes/No questions)

Collection 36c (FIG. 3A), on display 32c, contains examples of Yes/No questions pertaining to a “Pain or Injury” scenario 34c. The questions are:
Do you fee OK?
Are you in pain?
Does it hurt when I push here?
Did this hurt yesterday? Two days ago?
Do you understand why I′m doing this?
   Also contained on display 32c is advice 38c on how not to phrase a question for scenario 34c:
Instead of: “How do you feel?” Ask: (the above Yes/No questions)

Collection 36d (FIG. 3A), on display 32d, contains examples of Yes/No questions pertaining to a “Shopping” scenario 34d. The questions are:
Do you want some bananas?
Do you need more tissues?
Do you like clothes shopping?
Do you like the red one better than the blue one?
Do you have enough money to purchase that?
   Also contained on display 32d is advice 38d on how not to phrase a question for scenario 34d:
Instead of: “What do you want?” Ask: (the above Yes/No questions)

Collection 36e (FIG. 3B), on display 32e, contains examples of Yes/No questions pertaining to a “School” scenario 34e. The questions are:
Are you in school?
Do you like school?
Do you like reading better than math?
Is your teacher nice?
Do you understand this question?
   Also contained on display 32e is advice 38e on how not to phrase a question for scenario 34e:
Instead of: “Where do you go to school?” Ask: (the above Yes/No questions)

Collection 36f (FIG. 3B), on display 32f, contains examples of Yes/No questions pertaining to a “Hobbies/Interests” scenario 34f. The questions are:
Do you like to watch game shows?
Is “Frozen” your favorite movie?
Do you want John to do this with you?
Do you want me to read a book to you?
Are you better at this than your brother?
   Also contained on display 32f is advice 38f on how not to phrase a question for scenario 34f:
Instead of: “What do you like to do?” Ask: (the above Yes/No questions)

Collection 36g (FIG. 3B), on display 32g, contains examples of Yes/No questions pertaining to a “Sporting Event” scenario 34g. The questions are:
Do you like the blue team better than the red team?
Is your team winning?
Did you like to play soccer?
Do you know someone on the team?
Do you understand the rules?
   Also contained on display 32g is advice 38g on how not to phrase a question for scenario 34g:
Instead of: “Who is your favorite team?” Ask: (the above Yes/No questions)

Collection 36h (FIG. 3B), on display 32h, contains examples of Yes/No questions pertaining to a “General Conversation” scenario 34h. The questions are:
Are you having a good day?
Are you happy?
Do you like the weather today?
Do you like this place?
Do you want me to help you with that?
   Also contained on display 32h is advice 38h on how not to phrase a question for scenario 34h:
Instead of: “How are you?” Ask: (the above Yes/No questions)

Collection 36i (FIG. 3C), on display 32i, contains examples of Yes/No questions pertaining to a “Physical Therapy” scenario 34i. The questions are:
Do you want to exercise?
Do you want to stretch?
It that too much? (stretching or resistance)
Is that just right? (stretching or resistance)
Do you want to work the arms?
Do you want to work the legs?
Do you want to rest?
Do you want to continue?
Do you want to work in the wheelchair?
Do you want to work on the bed?
   Also contained on display 32i is advice 38i on how not to phrase a question for scenario 34i:
Instead of: “Do you want to exercise or stretch today?” Ask: (the above Yes/No questions)
   The above “Physical Therapy” Yes/No questions give the NV/L communicator an active role in his or her physical therapy session.

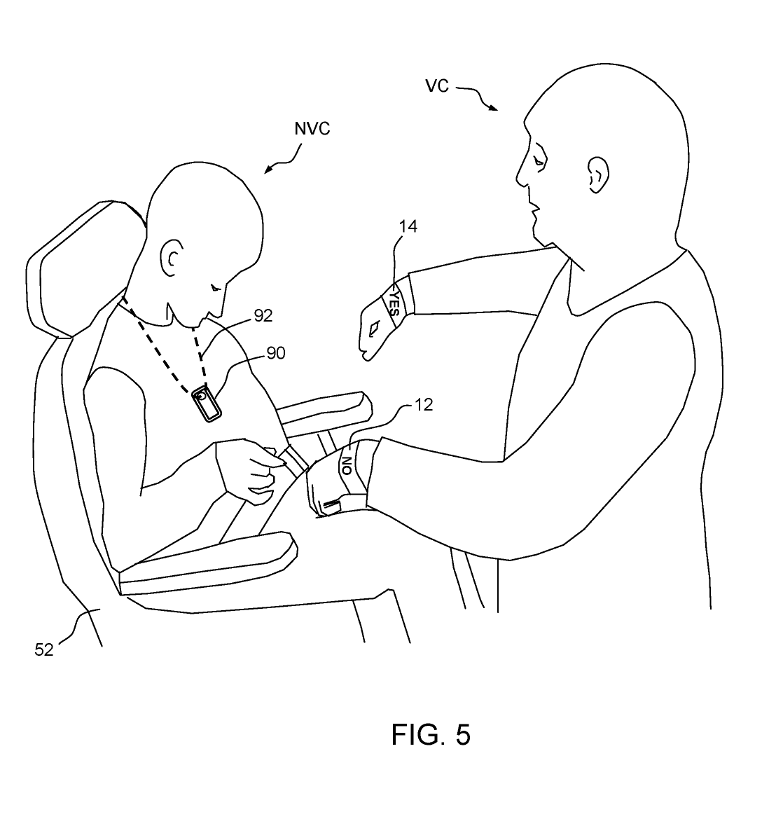

Displays 32a-32i can be implemented in a number of different ways. For example, each display may be printed on individual laminated paperboard cards, panels, or sheets of paper. Another example is shown in FIG. 4A, which illustrates that displays 32a-32i may be printed on sections of a fan-folded, pocket-sized, paperboard card 40. FIG. 4B illustrates a further example, where displays 32a-32i may be printed on pages bound in a pocket-sized booklet 42. FIG. 4C illustrates that displays 32a-32i may be formed on an electronic display screen of a smart phone 44. Generally, displays 32a-32i may be realized on any electronic display generated by a computer program application running on a personal commuter, laptop, electronic tablet, smart phone, or other personal electronic device. Each display 32a-32i, alone or in combination, may be considered and used as a portable guide, to be referred to by the verbal communicator before, during and after a conversation with a NV/L communicator.

Referring now to FIG. 5, No and Yes bands 12 and 14 are shown being worn around the wrists of a verbal communicator VC. Communicator VC is presenting the bands as “Yes” and “No” answer choices to a nonverbal communicator NVC sitting in a chair 52. At the same time, communicator VC is asking communicator NVC a Yes/No question. Initially, a basic question or questions (not requiring much thought) should be asked as a test to make sure communicator NVC understands the means of communication. For example, one basic question could be, “Is your name >>correct name of communicator NVC<<?” If communicator NVC responds affirmatively, then communicator VC may be confident that communicator NVC understands and a more involved Yes/No question may be asked. In FIG. 5, verbal communicator VC has asked another question and communicator NVC is shown answering in the negative. Communicator VC receives the negative or “No” answer in the form of a discriminating action made by communicator NVC toward the “No” answer choice presented by band 12. In FIG. 5, the discriminating action is a body lean or movement toward the side of band 12 and a hand movement or a point toward band 12. Other types of discriminating actions relative to band 12 or band 14 may include, for example, a head nod, eye glance, left or right eye blink, various motions toward or near the selected answer choice, touching the hand, wrist or arm carrying the selected band, or by a sound or sounds. A further discriminating action relative to band 12 or band 14 may simply be looking down or away from communicator VC for a negative response and looking up or at communicator VC for an affirmative response.

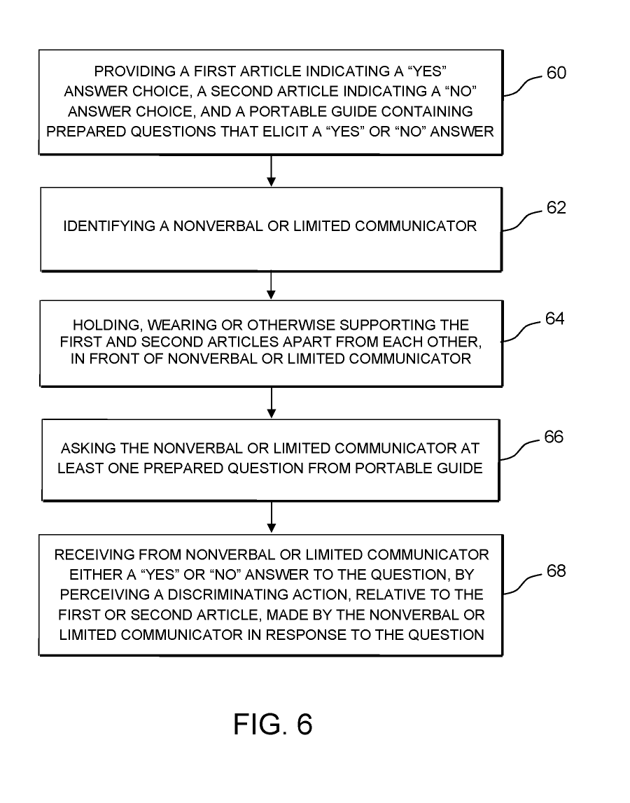

Referring now to FIG. 6, there is shown a flow diagram outlining a series of steps of a preferred method of communicating with a NV/L communicator, in accordance with the present invention. The method in FIG. 6 is but one example; the present invention is not so limited. A first step 60 (FIG. 6) involves providing a first article indicating a “Yes” answer choice, a second article indicating a “No” choice, and a portable guide containing prepared questions that elicit a “Yes” or “No” answer. A second step 62 involves identifying a nonverbal or limited communicator. A third step 64 involves holding, wearing or otherwise supporting the first and the second articles apart from each other, in front of the NV/L communicator. This is done so that the “Yes” and “No” answer choices are easily discernable and selectable by the NV/L communicator by making a discriminating action relative to the first or the second article. Step 64 is illustrated in FIG. 5, where bands 12 and 14 are worn around the wrists of the questioner (VC) and presented by to the NV/L communicator (NVC) as “Yes” and “No” answer choices. A fourth step 66 involves asking the NV/L communicator at least one of the prepared questions from the portable guide. Lastly, a fifth step 68 involves receiving from the NV/L communicator either a “Yes” or a “No” answer to a question asked in step 66, by perceiving a discriminating action, relative to the first or the second article, made by the NV/L communicator in response to the question.

As indicated above, No and Yes bands 12 and 14 should be first introduced to the NV/L communicator to make sure the NV/L communicator understands how the verbal communicator proposes to communicate. For example, the verbal communicator might say:
“I have these yes/no wristbands that I would like to try to use with you today.
This green one means ‘Yes.’”
   Then shake the wrist with the green band and make sure the NV/L communicator looks at it. Then ask a clearly true statement, e.g.,
“Am I a person? Yes!”
   Then continue:
“This red one means ‘No.’”
   Similarly, shake the other wrist with the red band and make sure the NV/L communicator can see it. Then ask a clearly false statement, e.g.,
“Am I a frog? No!”
   Next, the verbal communicator should confirm that the NV/L communicator can identify the correct color and meaning of bands 12 and 14 by putting his or her hands behind his or her back for a moment. Then the verbal communicator should present both options (bands 12 & 14) to the NV/L communicator and ask:
“Can you find the green ‘Yes’ wristband for me, please?”
   The verbal communicator should wait for visual, physical or verbal confirmation from the NV/L communicator. Then the verbal communicator repeats the question with respect to the other choice:
“Can you find the red ‘No’ wristband for me, please?”
   When the NV/L communicator successfully identifies both bands 12 and 14, the verbal communicator may then use bands 12 & 14 to communicate further with the NV/L communicator by asking one or more substantive yes/no questions.

Further exemplary dialog and interaction between a verbal communicator (“VC”) and a NV/L communicator is now presented:
VC: “Your going to tell me ‘yes’ or ‘no’ with these Yes/No bands, do you understand?”
NV/L: Some physical or verbal action indicating understanding.
VC: “I want you to answer ‘yes’ to questions by touching this (right) hand (band 14 is on right wrist); Green says ‘yes,’ ‘yes’.”
NV/L: Some physical or verbal action indicating understanding.
VC: “I want you to answer ‘no’ to questions by touching this (left) hand (band 12 is on left wrist); Red says ‘no,’ ‘no’.”
NV/L: Some physical or verbal action indicating understanding.
VC: (Holding out both hands) “Which one says “Yes”?
NV/L: Responds by touching VC's right hand, indicating that NV/L understands which band means “yes.”
VC: Reinforces correct response by saying, “Good, green is ‘yes’.”
VC: (Again holding out both hands) “Which one says “No,”?
NV/L: Responds by touching VC's left hand, indicating that NV/L understands which band means “no.”
VC: Reinforces correct response by saying, “You got it, red is ‘no,’ great job.”
VC: Asks basic yes/no questions to test whether NV/L can process a yes/no question. “Is your name John, yes or no?” (knowing NV/L communicator is named John)
NV/L: Responds by touching VC's right hand, indicating he understands the question.
VC: Asks a more involved yes/no question—one that may require the NV/L communicator to think about how he feels or what he wants. For example, “John, are you hungry, yes or no?”
NV/L: Responds by touching VC's right hand, indicating that he is hungry.
VC: “Do you want to eat pizza for dinner, yes or no?”
NV/L: Responds by touching VC's left hand, indicating he does not want pizza.
VC: Confirms response by saying, “No, you don't want pizza.”
VC: “Would you like tacos for dinner?”
NV/L: Responds by touching VC's right hand, indicating he wants tacos.
VC: Confirms response by saying, “Yes.”
VC: Further praises the NV/L communicator by saying, “Good job,” and this may also signal the end of the questioning.

No and Yes bands 12 and 14 make it possible to communicate with a NV/L communicator in most any environment or situation. For example, they are useful in a car, in a plane, in a train, in a pool, in the rain, in the snow, on the go, during gym activities, during physical therapy, etc. Bands 12 and 14 are reliable and can be quicker, easier and more enjoyable to use than other devices.

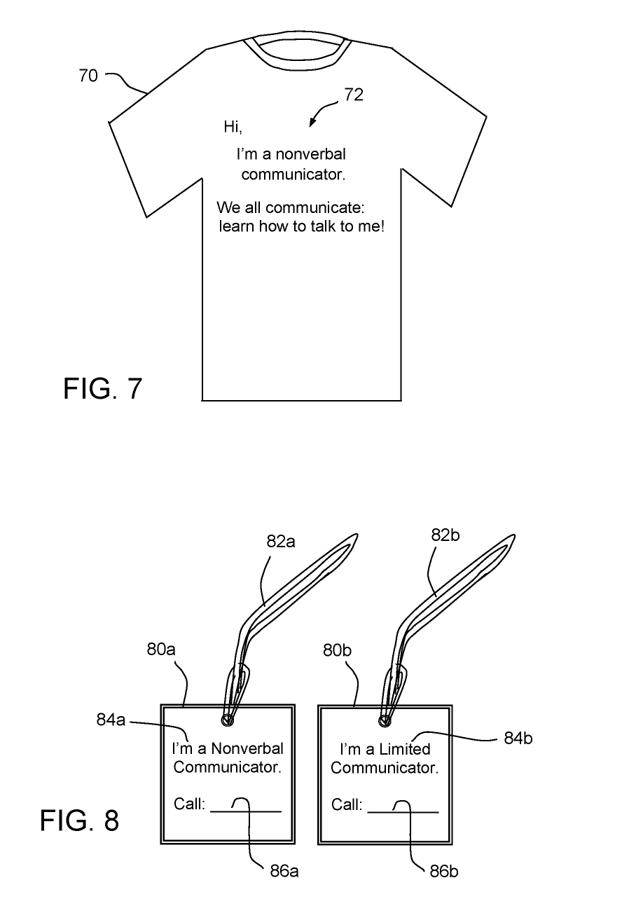

Referring now to FIGS. 7-10, there is shown various means of identifying a NV/L communicator. Identification is not necessarily limited to identifying the NV/L communicator by name. Its meaning preferably includes an indication to others (e.g., the verbal community) that the NV/L communicator is indeed a communicator and ready, willing and able to communicate. FIG. 7 shows a T-shirt 70 to be worn by the NV/L communicator. Shirt 70 contains a greeting 72 on the front panel of the shirt that identifies the wearer as a nonverbal (or “limited”) communicator, conveys the message that “we” (verbal and nonverbal alike) all communicate, and invites others to learn how to talk to the wearer of the T-shirt. By wearing shirt 70, a person serves as an ambassador for the NV/L community, spreading the word that NV/L communicators can communicate and verbal communicators can and should communicate with NV/L communicators.

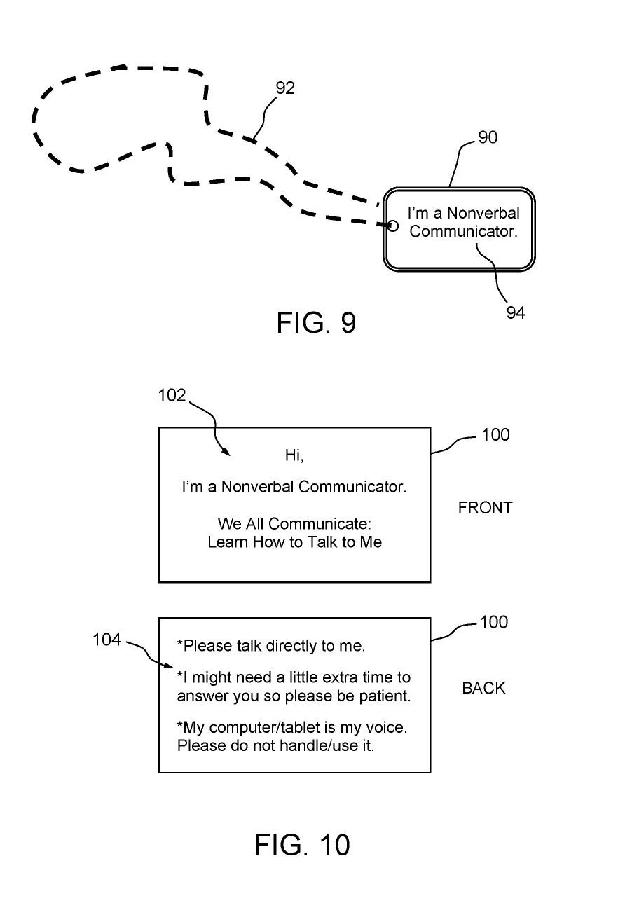

FIG. 8 shows two ID tags 80a and 80b to be tied to the clothing, backpack or wheelchair of a NV/L communicator, using straps 82a and 82b. Tag 80a contains a statement 84a that identifies the wearer as a nonverbal communicator, and tag 80b contains a statement 84b that identifies the wearer as a limited communicator. Tags 80a and 80b also contain a box or line 86a and 86b, respectively, for marking the tag with a phone number of a guardian or other caregiver (in case the NV/L communicator is lost or in case of an emergency). Similarly, FIG. 9 shows a dog tag 90 with a neck chain 92. Tag 90 is worn around the neck of a NV/L communicator (see FIG. 5). Tag 90 contains a statement 94 that identifies the wearer as a nonverbal communicator. In FIG. 10, the front and back of a communication card 100 (like a business card) is shown. Card 100 is to be carried by a NV/L communicator. Similar to shirt 70, card 100 contains a greeting 102 on the front that identifies the wearer as a nonverbal (or “limited”) communicator, conveys the message that “we” all communicate, and invites others to learn how to talk to the card holder. The back of card 100 contains instructions 104 to verbal communicators on how to talk to the NV/L communicator and advises against handling or using the NV/L communicator's electronic AAC device. Card 100 may be customizable to the specific needs and desires of the NV/L communicator (e.g., it may further contain contact information of a guardian or caregiver).

The various means of identifying a NV/L communicator (discussed above with reference to FIGS. 7-10) were developed to help identify individuals with communication challenges and prevent crises that arise because of a communication problem. For example, a girl, who was a limited communicator, was accidentally left behind on a field trip to an amusement park and was lost for six hours with no way of contacting her parents or asking for help. If the girl had ID tag 80b (FIG. 8) tied to her clothing or backpack, a park attendant would have been able to understand the handicap and the situation and would have been able to quickly call a parent or other guardian listed on the tag. In another example, a boy (a limited communicator) and his dad were out skiing. The boy looked like a typical teenager. As they were riding up a chairlift, the boy fell off. His dad could not jump off because the lift went higher and it was too dangerous. The boy was alone on the mountain and could not tell anyone. Another skier finally came along and asked the boy if he wanted help getting back on the lift, and the boy indicated that he did. The boy was put on the lift, but he did not know how to put the safety bar down. He rode on the lift up the mountain without the safety bar down. He was okay, but his dad was upset that he was put on the lift alone. If the boy had ID tag 80b tied to his coat, the person that helped him would have understood the boy's handicap and would have hopefully called the dad's number on the tag. It is easy to be separated from a loved one who has a communication challenge. The means of identification shown in FIG. 7-10 can be an important tool in avoiding a crisis. ID tags 80a & 80b can be especially useful to medical and emergency personnel, who are trained to look for identification information.

In another example regarding identification, a girl, who was a limited communicator, was at her dentist. While she was busy typing a message to her dentist on her AAC tablet, a dental assistant firmly told her to put the tablet away so the dentist could examine her. She became frustrated and angry. The dental assistant did not know the girl was attempting to use an AAC device to communicate. The girl needed a way to let people know she was a limited communicator and needed her tablet to communicate. Communication card 100 (FIG. 10) would have been a useful tool in this situation to alert and educate the dental assistant and the dentist about her handicap and means of communication. All the girl would have had to do was hand out card 100 to the dentist and the assistant to avoid the problem. Communication cards 100 can be passed out to friends, family, teachers, dentists, doctors, caretakers, and others throughout the verbal community. Communication cards 100 can be personalized with more specific details about communicating with a particular NV/L communicator.

No and Yes bands 12 and 14, t-shirts 70, ID tags 80a & 80b, dog tags 90, communication cards 100, instructions on use, and an informative guidebook are supplied by CHAT COLLECTIVE, INC., Fayetteville, N.Y., www.chatcollective.com.

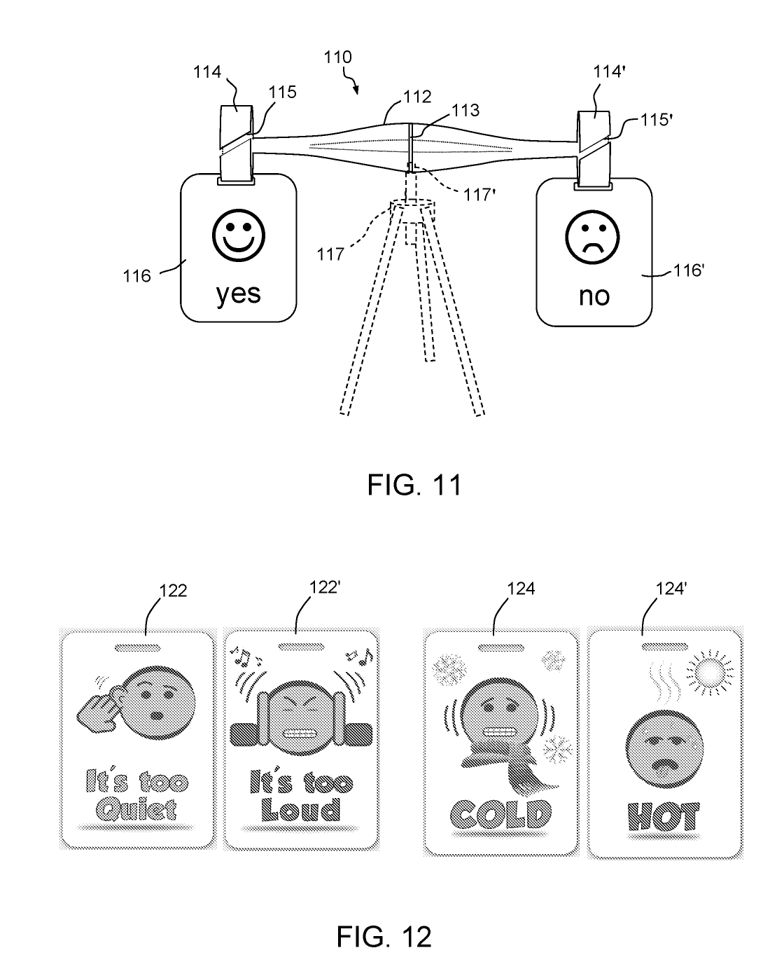

Turning now to FIG. 11, there is shown a flipchart framework 110 having a boom 112 and a pair of integrally formed card rings 114 and 114′. Framework 110 is preferably made of injection molded (snap-together) plastic parts. Boom 112 is generally constructed of two haves hinged together (not shown) behind a split 113, such that boom 112 can be folded in half for storage. Each card ring contains an open slot 115, 115′ to allow flipchart cards to be mounted on or removed from rings 114, 114′. Each ring includes one or more flipchart cards 116, 116′ to create a pair of flipcharts at each end of boom 112. In this example, flipchart cards 116 and 116′ are marked “yes” and “no,” respectively, for the purpose of presenting yes and no choices to a NV/L communicator. Also, in this example, framework 110 is supported by an extrinsic support structure 117 (e.g., a tripod, as shown). Boom 112 contains a small bore (not shown) on its bottom side, which is dimensioned to tightly receive a pin 117′ projecting upward from the top of tripod 117. Extrinsic support structure 117 may alternatively be, e.g., a wheelchair, another type of chair, a railing, a table, a bed, or other fixture. Framework 110 does not need to be supported by an extrinsic support structure; it may be hand-held while being used or transported.

Framework 110 demonstrates that other forms of articles can be used to present a NV/L communicator with answer choices, such as “Yes” and “No” answer choices, in accordance with the present invention. In FIG. 11, flipchart card 116 is an article indicating an affirmative answer choice, and flipchart card 116′ is an article indicating a negative answer choice. A verbal communicator may use framework 110 to present the “Yes” & “No” answer choices to a NV/L communicator, while asking one or more Yes/No questions, in accordance with the methods described above.

Communication between a verbal communicator and a NV/L communicator may extend beyond just Yes and No. For example, as shown in FIG. 12, additional flipchart cards may be used in the flipcharts of framework 110 (FIG. 11) to support other forms of “binary” questions (i.e., questions eliciting a binary response). Two examples of additional flipchart cards are shown in FIG. 12. Cards 122 and 122′ involve one example and cards 124 and 124′ involve another example. Cards 122 and 124 are installed on ring 114 and cards 122′ and 124′ are installed on ring 114′. In the first example, the verbal communicator first displays cards 122, 122′ on rings 114, 114′, respectively, and presents them to the NV/L communicator. The verbal communicator then asks the NV/L communicator whether, e.g., a particular audio or audiovisual program is too quiet or too loud (binary—one or the other). The NV/L communicator should then respond (as previously described) by making a discriminating action relative to card 122 or card 122′. In the second example, the verbal communicator displays cards 124, 124′ on rings 114, 114′, respectively, and presents them to the NV/L communicator. The verbal communicator then asks the NV/L communicator whether, e.g., he or she is hot or cold. The NV/L communicator should then respond by making a discriminating action relative to card 124 or card 124′. In some circumstances, framework 110 with flipchart cards may be a more versatile means of communication than bands 12 & 14, in the sense that the questioning can extend beyond Yes/No.

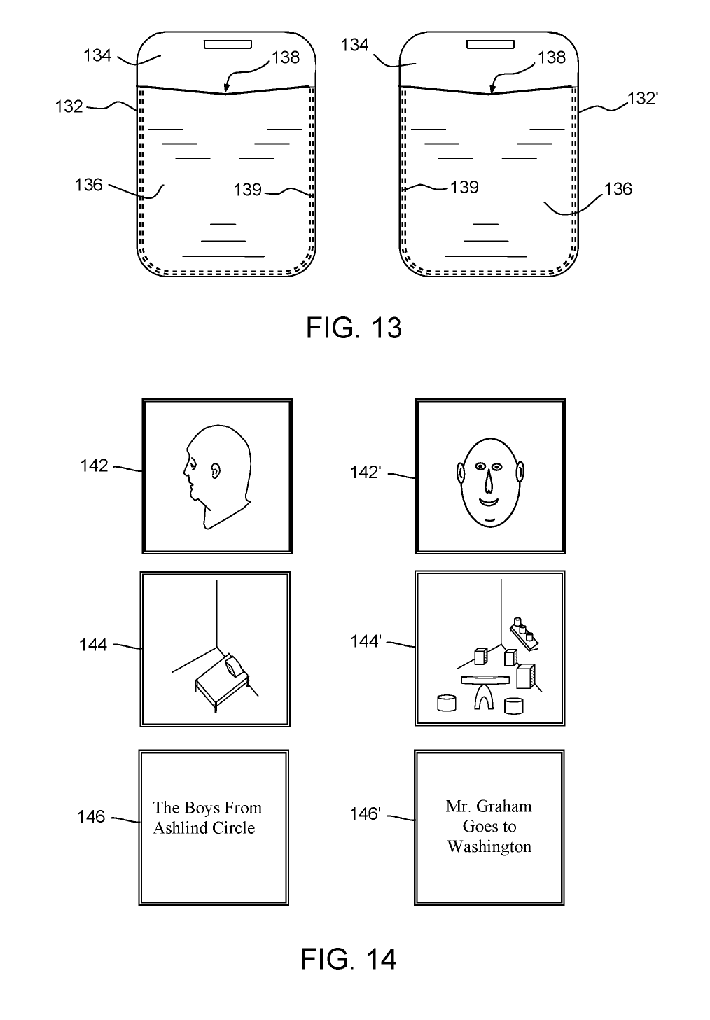

Referring now to FIG. 13, there is shown an alternative form of a flipchart card. Two blank flipchart cards 132 and 132′ are shown. Cards 132 and 132′ are intended to be used on rings 114, 114′, respectively, of framework 110. Cards 132, 132′ each have a plastic back panel 134 and a clear plastic front panel 136. Panel 136 is affixed to panel 134 along three edges of panel 136, as shown. Panel 134 and panel 136 create a transparent pocket or sleeve with an opening 138. Back panel 134 and clear panel 136 may be constructed of the same material, such as polyurethane film, vinyl or polyethylene sheet material, and may be held together by heat sealing or sonic welding or by an appropriate adhesive, or both. In FIG. 13, panel 136 is heat sealed to panel 134, as indicated by a heat seal seam 139. In a variation of the construction, panel 134 may be made of a stiff plastic sheet or laminated paperboard or cardstock material and panel 136 may be made of clear vinyl or polyethylene. In this variation, any suitable means for affixing panel 136 to panel 134 can be employed.

Blank cards 132, 132′ allow one to personalize communication with a NV/L communicator. Cards 132, 132′ can be personalized with specific and familiar subjects, such as photos of friends, movie, TV show or song titles, favorite toys or games, places or rooms important only to the NV/L communicator (e.g., school, park, bedroom, playroom, or office), etc. FIG. 14 shows sheets 142 and 142′ each containing a printed image or photograph of a person familiar to the NV/L communicator. Sheets 142 and 142′ are slipped into the sleeves of cards 132 and 132′, respectively, such that the images or photos of the familiar persons are visible through clear plastic panels 136. Thus, cards 132 and 132′ are customized to present a choice to the NV/L communicator between two familiar people. Customized cards 132 and 132′ are installed on flipchart rings 114 and 114′, respectively, and the choice is presented to the NV/L communicator by holding (or supporting by an extrinsic support) framework 100 in front of the NV/L communicator. In this example, a verbal communicator may ask the NV/L communicator which person he or she would like to visit today. The NV/L communicator should then answer by making a discriminating action relative to customized card 132 or card 132′.

FIG. 14 shows two other examples. Sheets 144 and 144′ each contain a printed image or photograph of a room familiar to the NV/L communicator. Sheet 144 shows an image of a bedroom and sheet 144′ shows an image of a playroom. Sheets 144 and 144′ are slipped into the sleeves of cards 132 and 132′, respectively, and their images are visible through panels 136. Cards 132 and 132′ are now customized to present a choice to the NV/L communicator about which room he or she prefers. As before, cards 132 and 132′ are installed on rings 114 and 114′, respectively, and the choice is presented to the NV/L communicator using framework 100 (as described above). In this example, the NV/L communicator may be asked whether he or she would like to move to the bedroom or playroom. The NV/L communicator should then answer by making a discriminating action relative to customized cards 132, 132′. Another example concerns sheets 146 and 146′. Sheet 146 displays a television show title, “The Boys from Ashlind Circle,” and sheet 146′ displays a movie title, “Mr. Graham Goes to Washington.” Sheets 146 and 146′ are slipped into the sleeves of cards 132 and 132′, respectively, and their images are presented as choices to the NV/L communicator. As before, cards 132 and 132′ are installed on rings 114 and 114′, respectively, and the choice is presented using framework 100 (as described above). In this last example, the NV/L communicator may be asked whether he or she would like to watch “The Boys From Ashlind Circle” or “Mr. Graham Goes to Washington.” The NV/L communicator should then answer by making a discriminating action relative to one card or the other.

With the use of blank cards 132, 132′, communication is only limited by the imagination, interests and needs of the participants. Sheets 142, 142′, 144, 144′, and 146, 146′ can be sheets of printer or copy paper or cardstock. The words, symbols or images can be easily created and printed on the paper or cardstock using, for example, a personal computer and printer. This allows family members, teachers, therapists, caregivers, and others to prepare a customized set of choices which are unique, personal, meaningful, important, and/or familiar to a particular NV/L communicator. The subjects and choices are tailored to the NV/L communicator's own personal environment and activities.

Advantages and features of the present invention include, but are not limited to: (1) creates awareness, especially among the general public, that NV/L communicators can and are willing to communicate with others; (2) promotes meaningful and sociable communication between verbal communicators and NV/L communicators; (3) enables an untrained member of the general public to communicate easily and effectively with a NV/L communicator; (4) provides a reliable, low tech backup plan for communications, in case electronic AAC devices fail, are unavailable, or are impractical to operate under the circumstances; (5) provides a means to positively identify the NV/L as a nonverbal or limited communicator and to convey the message that the NV/L communicator can and is willing to communicate; (6) it helps improve the confidence level of families, teachers, healthcare providers, other caregivers, and the general public in interacting, communicating and socializing with NV/L communicators; (7) improves quality of life and promotes physical and emotional growth of NV/L communicators by expanding their opportunities for communication; and (8) provides an expeditious means of communicating with a NV/L communicator in the case of a medical emergency or other crises.

While the preferred embodiments of the invention have been particularly described in the specification and illustrated in the drawing, it should be understood that the invention is not so limited. Many modifications, equivalents and adaptations of the invention will become apparent to those skilled in the art without departing from the spirit and scope of the invention, as defined in the appended claims.

What I claim is:

1. A method of enabling a verbal communicator to communicate with a nonverbal or limited communicator in an particular activity, using a first article indicating a first answer choice, a second article indicating a second answer choice, and a portable guide containing a collection of prepared questions associated with the activity, each of the prepared questions eliciting an answer of either the first or the second answer choice, said method comprising the steps of:
(a) referring to the portable guide to review the collection of prepared questions associated with the activity;
(b) supporting the first and the second articles apart from each other in front of the nonverbal or limited communicator, such that the first and the second answer choices are easily discernable and are selectable by the nonverbal or limited communicator by a discriminating action of the nonverbal or limited communicator in relation to the first or the second article;
(c) asking the nonverbal or limited communicator at least one of the prepared questions of the collection of prepared questions from the portable guide; and
(d) receiving from the nonverbal or limited communicator an answer of either the first or the second answer choice to the at least one prepared question, by perceiving a discriminating action by the nonverbal or limited communicator in relation to the first or the second article.

2. The method of claim 1, wherein the portable guide further contains guidance on phrasing a question, associated with the activity, to elicit an answer of either the first or the second answer choice.

3. The method of claim 1, wherein the portable guide identifies a plurality of activities and contains a plurality of collections of prepared questions associated with the plurality of activities, respectively, the plurality of activities including the particular activity, and wherein step (a) includes referring to the portable guide to identify the particular activity among the plurality of activities.

4. The method of claim 1, wherein the portable guide is pocket-sized, and wherein step (a) includes referring to the pocket-sized portable guide to review the collection of prepared questions of the activity.

5. The method of claim 1, wherein the portable guide is a fan-fold card, and wherein step (a) includes referring to the fan-fold card to review the collection of prepared questions of the activity.

6. The method of claim 1, wherein the portable guide is a booklet, and wherein step (a) includes referring to the booklet to review the collection of prepared questions of the activity.

7. The method of claim 1, wherein the portable guide includes a plurality of electronic screen displays associated with a portable electronic device, the screen displays being generated by a computer program operating on the portable electronic device, and wherein step (a) includes referring to one or more of the screen displays to review the collection of prepared questions associated with the activity.

8. The method of claim 1, wherein the first and the second articles are wearable articles, and wherein step (b) includes wearing the wearable articles.

9. The method of claim 8, wherein step (b) includes wearing the wearable articles on the verbal communicator's hands or wrists, respectively.

10. The method of claim 9, wherein the wearable articles are wristbands or bracelets, and wherein step (b) includes wearing the wristbands or bracelets on the verbal communicator's hands or wrists, respectively.

11. The method of claim 1, wherein the first and the second articles are first and second flipchart cards indicating the first and the second answer choices, respectively, and wherein step (b) includes supporting the first and the second flipchart cards apart from each other in front of the nonverbal or limited communicator.

12. The method of claim 11, wherein step (b) includes supporting the first and the second flipchart cards on a flipchart framework, the flipchart framework including a boom and first and second flipchart rings coupled to the boom and spaced apart from each other along the boom, the first and the second flipchart rings being configured to receive and support the first and the second flipchart cards, respectively.

13. The method of claim 11, further comprising the step of:
(e) customizing the first and the second answer choices of the first and the second flipchart cards, respectively, such that the answer choices are personalized to the nonverbal or limited communicator.

14. The method of claim 1, further comprising step of:
(e) identifying the nonverbal or limited communicator as being verbally handicapped in response to a messaged displayed in association with the nonverbal or limited communicator.

15. The method of claim 1, further comprising step of:
(e) displaying to the verbal communicator a message associated with the nonverbal or limited communicator, the message indicating that the nonverbal or limited communicator is verbally handicapped, is a communicator, and is willing to communicate with the verbal communicator.

16. The method of claim 15, wherein step (e) includes displaying the message on a t- shirt worn by the nonverbal or limited communicator.

17. The method of claim 15, wherein step (e) includes displaying the message on an identification tag or a dog tag associated with the nonverbal or limited communicator.

18. The method of claim 1, wherein the first and the second answer choices of the first and the second articles are affirmative and negative answer choices, respectively, and wherein each of the prepared questions of the collection in the portable guide elicit an answer of either the affirmative or the negative answer choice.

19. A method of enabling a verbal communicator to communicate with a nonverbal or limited communicator in an particular activity, using a first article indicating an affirmative answer choice, a second article indicating a negative answer choice, and a portable guide containing a collection of prepared questions associated with the activity, each of the prepared questions eliciting an answer of either the affirmative or the negative answer choice, said method comprising the steps of:
(a) referring to the portable guide to review the collection of prepared questions associated with the activity;
(b) supporting the first and the second articles apart from each other in front of the nonverbal or limited communicator, such that the affirmative and the negative answer choices are easily discernable and are selectable by the nonverbal or limited communicator by a discriminating action of the nonverbal or limited communicator in relation to the first or the second article;
(c) asking the nonverbal or limited communicator at least one of the prepared questions of the collection of prepared questions from the portable guide; and
(d) receiving from the nonverbal or limited communicator an answer of either the affirmative or the negative answer choice to the at least one prepared question, by perceiving a discriminating action by the nonverbal or limited communicator in relation to the first or the second article.

20. A method of enabling a verbal communicator to communicate with a nonverbal or limited communicator in an particular activity, using a first article indicating an affirmative answer choice, a second article indicating a negative answer choice, and a portable guide identifying the activity and containing a collection of prepared questions associated with the activity, each of the prepared questions eliciting an answer of either the affirmative or the negative answer choice, said method comprising the steps of:
(a) identifying the nonverbal or limited communicator as being verbally handicapped;
(b) referring to the portable guide to identify the particular activity and review the collection of prepared questions associated with the activity;
(c) supporting the first and the second articles apart from each other in front of the nonverbal or limited communicator, such that the affirmative and the negative answer choices are easily discernable and are selectable by the nonverbal or limited communicator by a discriminating action of the nonverbal or limited communicator in relation to the first or the second article;
(d) asking the nonverbal or limited communicator at least one of the prepared questions of the collection of prepared questions, for the identified activity, from the portable guide; and
(e) receiving from the nonverbal or limited communicator an answer of either the affirmative or the negative answer choice to the at least one prepared question, by perceiving a discriminating action by the nonverbal or limited communicator in relation to the first or the second article.
